(19) United States
(12) Patent Application Publication
(10) Pub. No.: US 2003/0080848 A1
(43) Pub. Date: May 1, 2003

(54) Unitary arrester housing and support bracket

(75) Inventors: John A. Krause, Medina, OH (US); Randall K. Niedermier, Akron, OH (US)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Hubbell Incorporated

(21) Appl. No.: 09/984,175

(22) Filed: Oct. 29, 2001

(51) Int. Cl. H02H 9/06; H02H 7/24; H01C 7/12; H01T 4/00; H01T 4/04

(52) U.S. Cl. 337/19; 337/20; 337/15; 361/117

(57) ABSTRACT

An arrester includes a dielectric housing that has a body portion that includes a substantially cylindrical wall with opposing first and second ends that form inner cavity therebetween. A support mounting bracket portion is formed as a unitary, one-piece extension of the body portion and extends laterally from said second end. The housing has sufficient rigidity to maintain the bracket portion in a position substantially perpendicular to the body portion. At least one varistor element is received in the inner cavity of the housing.

### BACKGROUND OF THE INVENTION

A surge arrester is a protective device for power distribution systems. In particular, a surge arrester directs any over current in the system to ground. Conventional surge arresters include a current path to ground through resistance or varistor elements that dissipate the surge in current without damage to the utility line equipment.

During a catastrophic failure, the arrester can no longer perform its function and must be removed from the system. To accomplish removal of the arrester, disconnectors are provided within the arrester, such as an explosive charge, to permanently separate the ground line from the arrester. A weakened or thinner section of the arrester directs the explosion at the physical connection of the arrester and the ground line.

Conventional arresters are mounted to a utility pole of the power distribution system by a standard NEMA bracket recommended by the National Electrical Manufactures Association attached to the utility pole. In particular, conventional arresters include separate rigid support brackets coupled to the arresters that mate with the NEMA bracket of the utility pole. The support brackets are generally formed separately and are made of a different material, such as polyester, than the housing of the arrester, thereby increasing costs and assembly time. Also, the support brackets of conventional arresters are easily damaged in both shipment and handling by utility lineman.

Examples of conventional arresters include U.S. Pat. No. 5,406,033 to Pazdirek; U.S. Pat. No. 5,434,550 to Putt; U.S. Pat. No. 4,609,902 to Lenk; and U.S. Pat. No. 4,972,291 to Cunningham.

### SUMMARY OF THE INVENTION

Accordingly, an object of the present invention is to provide an arrester than includes a unitary housing and support bracket.

Another object of the present invention is to provide an arrester that is easily assembled.

Yet another object of the present invention is to provide an arrester having a housing and support bracket formed of a material sufficiently rigid to support the arrester on a pole bracket and flexible enough to prevent damage to the arrester during shipping and handling of the arrester.

The foregoing objects are basically attained by an arrester comprising a dielectric housing that includes a body portion that has a substantially cylindrical wall with opposing first and second ends that form inner cavity therebetween. A support mounting bracket portion is formed as a unitary, one-piece extension of the body portion and extends laterally from the second end. The housing has sufficient rigidity to maintain the bracket portion in a position substantially perpendicular to the body portion. At least one varistor element is received in the inner cavity of the housing.

The foregoing objects are also attained by a method of making an arrester that has a dielectric housing that receives a plurality of varistor elements. The method comprises the steps of placing the plurality of varistor elements between first and second electrically conductive end terminals to form a block assembly, and molding the housing of the arrester around the block assembly so that the block assembly is received in a body portion of the housing and a support mounting bracket portion is formed as a unitary one-piece extension of the body portion.

By fashioning the arrester in the above manner, the arrester can be manufactured faster and with less cost, and damage to the arrester due to shipping an handling is largely reduced.

Other objects, advantages and salient features of the invention will become apparent from the following detailed description, which, taken in conjunction with annexed drawings, discloses the preferred embodiments of the present invention.

### BRIEF DESCRIPTION OF THE DRAWINGS

Referring to the drawings which form a part of this disclosure:

FIG. 1 is a side elevational view of an arrester in accordance with a first embodiment of the present invention, showing the arrester mounted to a utility pole bracket;

FIG. 2 is a side elevational view in section of the arrester illustrated in FIG. 1;

FIG. 3 is a top plan view of the arrester illustrated in FIG. 1, with a first conductive terminal connected to the arrester removed; and

FIG. 4 is a side elevational view in cross section of an arrester in accordance with a second embodiment of the present invention.

### DETAILED DESCRIPTION OF THE INVENTION

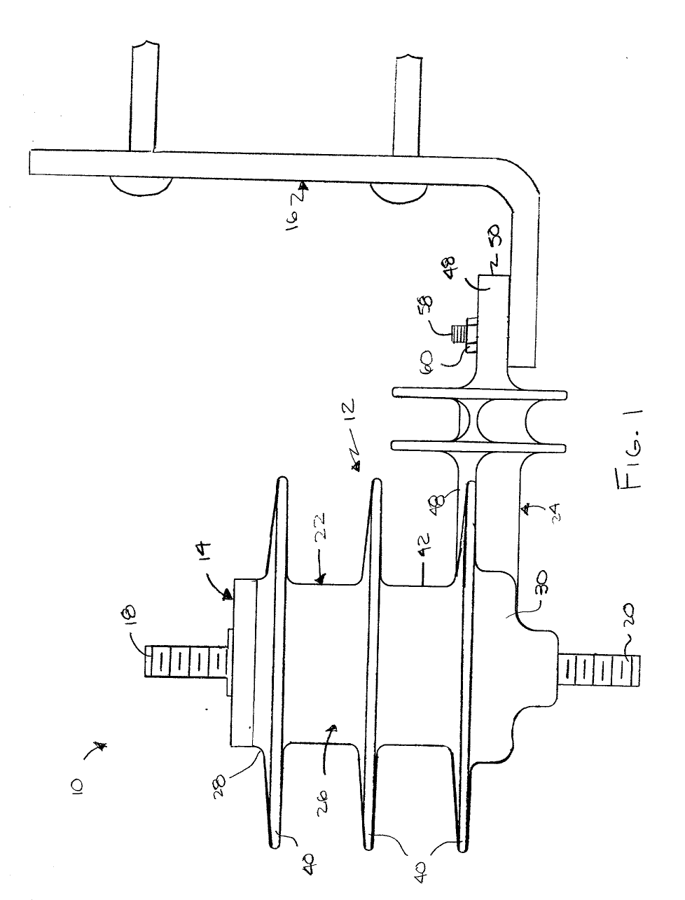

Referring to FIGS. 1-3, an arrester 10 in accordance with an embodiment of the present invention generally includes a housing 12 that receives a varistor block assembly 14. Arrester 10 is mountable to a utility pole of a power distribution system by a standard NEMA bracket 16, and provides protection for the system against over current, as is well known in the art. Block assembly 14 is electrically connectable to the power distribution system via first and second conductive terminals 18 and 20.

Housing 12 of arrester 10 includes a body portion 22 and a support mounting bracket portion 24 that extends from body portion 22, as seen in FIG. 1. Body portion 22 and bracket portion 24 form a one-piece unitary housing or member. A one-piece unitary member is defined as a single piece without a discernible dividing line, and does not include any portion that is separately formed and then attached to the member. Body portion 22 receives block assembly 14 and bracket portion 24 supports arrester 10 with respect to pole bracket 16.

One-piece unitary housing 12 is made of a dielectric plastic polymer blend capable of sustaining a mechanical load. Some examples of a plastic polymer blend include polypropylene, polyethylene, acrylate polymers, vinyl acetate, epoxy, and rubber plastic bends. The plastic polymer blend of housing 12 is described in detail in commonly assigned U.S. Pat. No. 6,031,186 to Sakich et al., the subject matter of which is hereby incorporated by reference, including details of the examplary plastic polymer composites. Housing 12 has sufficient rigidity to maintain bracket portion 24 in a substantially perpendicular position with respect to body portion 22 so that arrester 10 is substantially upright when mounted to pole bracket 16 via support bracket portion 24, as seen in FIG. 1. Housing 12 also has some flexibility that allows bracket portion 24 to slightly move or bend with respect to body portion 22. This flexibility assists in preventing damage to arrester 10 during shipping and handling, particularly damage to bracket portion 24.

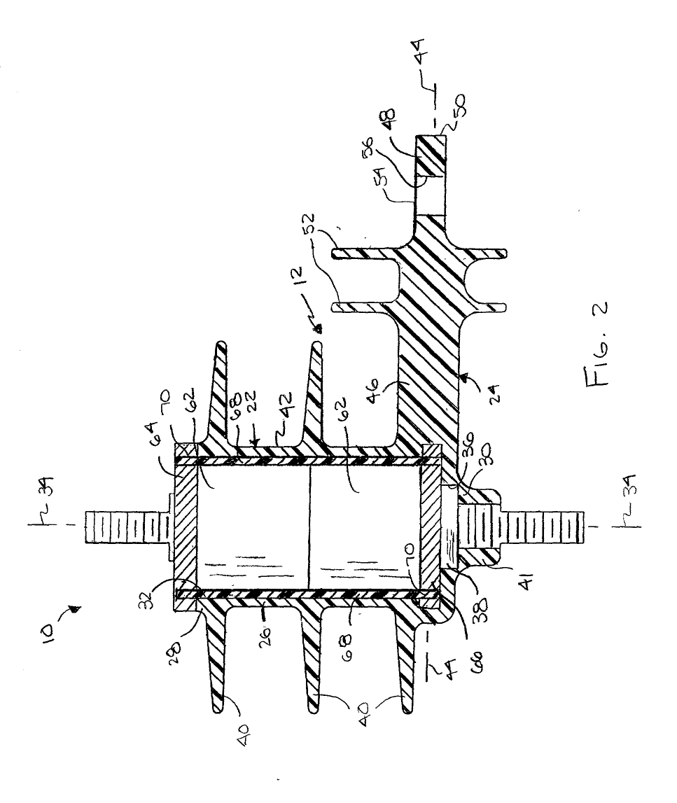

As seen in FIG. 2, body portion 22 of housing 12 generally includes a cylindrical wall 26 with opposing first and second ends 28 and 30 forming an inner cavity 32 therebetween for receiving block assembly 14 and defines a central longitudinal axis 34. First end 28 is near first conductive terminal 18 and is open to provide access to inner cavity 32. Second end 30 is unitary with bracket portion 24 and near second conductive terminal 20. A cavity 36 for receiving an explosive charge 38 is located in second end 30 between inner cavity 32 and second conductive terminal 20. Explosive charge 38 isolates arrester 10 during a catastrophic failure, as is well known in the art. A plurality of weather sheds 40 extend from an outer surface 42 of cylindrical wall 26, as is well known in the art. Although weather sheds 40 are preferably used, they are not required. Additionally, a weakened or thinner section 41 of arrester housing 12 is located at second end 30 near explosive charge 38 to provide a directed pressure relief during a failure, as is well known in the art.

Bracket portion 24 extends laterally from second end 30 of body portion 22 and defines a longitudinal axis 44, as seen in FIG. 2. Longitudinal axis 44 is substantially perpendicular to longitudinal axis 34 of body portion 22. Bracket portion 24 includes a generally cylindrical main section 46 extending from body portion 22 and a generally flat section 48 at a distal end 50 of bracket portion 24. Although main section 46 is preferably cylindrical, main section 46 can be any structural shape, such as square, T-shaped, or U-shaped. The size and thickness of section 48 is determined by the strength required to support arrester 10 on pole bracket 16. Weather sheds 52 are preferably employed which extend from tubular section 46, but are not required.

Flat section 48 includes a securing surface 54 that engages pole bracket 16. Specifically, securing surface 54 includes a fastening hole 56 disposed within flat section 48 that receives a fastener 58, as seen in FIGS. 1 and 2. Fastener 58, such as a screw, extends through a hole (not shown) of pole bracket 16 and through fastening hole 56 of flat section 48 with a nut 60 therebetween, thereby releasably mounting arrester 10 via bracket portion 24 to pole bracket 16. Although bracket portion 24 is preferably coupled with pole by a fastener and fastening hole arrangement, any known attachment can be used to secure bracket portion 24 of arrester 10 to bracket 16.

The varistor block assembly 14 received in arrester housing 12, generally includes conventional varistor elements or MOV blocks 62 stacked and compressed between first and second conductive end terminals 64 and 66, as best seen in FIG. 2. Varistor elements 62 are electrically connected to first and second conductive terminals 18 and 20, respectively, via first and second end terminals 64 and 66, respectively, as is well known in the art. End terminals 64 and 66 can alternatively be plastic with a direct electrical connection being between conductive terminals 18 and 20, respectively, and block assembly 14. This would require a hole (not shown) in each end terminal 64 and 66 to allow terminals 18 and 20, respectively, to extend therethrough and contact block assembly 14. Although two varistor elements are shown, more or less varistor elements can be employed.

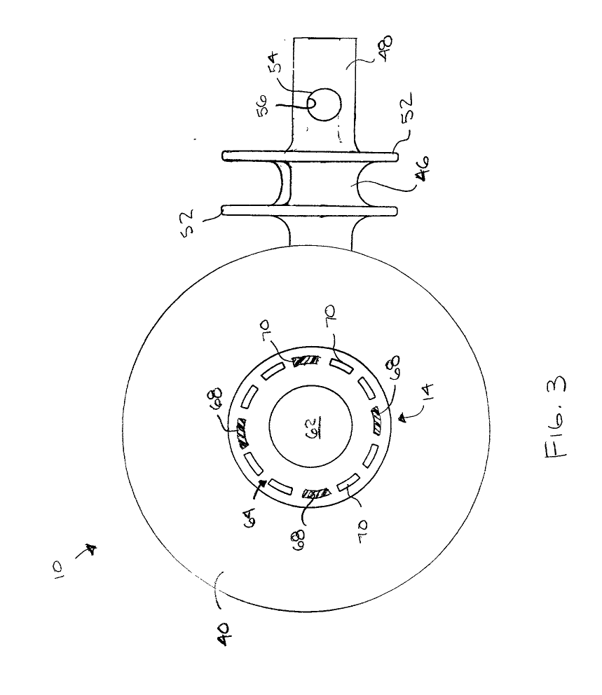

Varistor elements 62 are compressed together by rigid members or rods 68, as best seen in FIG. 2. Compression of varistor elements 62 ensures a good electrical connection between first and second conductive terminals 18 and 20 through block assembly 14. Rods 68 extend between first and second end terminals 64 and 66, as seen in FIG. 2, and are received in slots 70 of each end terminal, as seen in FIG. 3. Rods 68 are fixed to end terminals 64 and 68 by any known attachment such as wire ties or crimping. Rods 68 are preferably fiberglass rods but can be any rigid member. Although four rods 68 are shown in FIG. 3, any number of rods can be used, such as less than or greater than four. Conventional Belleville springs (not shown) can also be located between varistor elements 62 and each end terminal 64 and 66, respectively, to provide additional compression on varistor elements 62.

Assembly

Arrester 10 can be assembled by two different methods. The first method initially requires assembly of block assembly 14 by stacking varistor elements 62 between first and second end terminals 64 and 66, as is well known in the art. To complete the assembly of block assembly 14, rods 68 are placed between end terminals 64 and 66 and beside the stacked varistor elements 62 so that the ends of rods 68 extend through slots 70 of each end terminal 64 and 66. Compression force is then applied to end terminals 64 and 66 and varistor elements 62 through rods 68. Once compression is complete, the ends of rods 68 can be cut off to be generally flush with each end terminal 64 and 66, respectively.

Once block assembly 14 has been assembled, it is placed in a mold for arrester housing 12. Explosive charge 38 is also placed in the mold. Housing 12 can then be molded around block assembly 14 so that cylindrical wall 26 of body portion 22 surrounds block assembly 14 and first end terminal 64 of block assembly 14 closes off the open or first end 28 of body portion 22, as seen in FIG. 2. Also, second end 30 surrounds explosive charge 38. First conductive terminal 18 is connected to first end terminal 64 of block assembly 14 and second conductive terminal 20 extends into housing second end 30 and connects to second end terminal 66 with explosive charge 38 located therebetween.

The second method of assembling arrester 10 initially requires molding arrester housing 12. This is accomplished by placing a core mandrel (not shown) having the approximate size of block assembly 14 within the mold for housing 12. End terminal 66 and rods 68 of block assembly 14 are also placed in the mold with the core mandrel. Housing 12 can then be molded around the core mandrel, end terminal 66 and rods 68 extending through slots 70 of terminal 66 with cylindrical wall 26 of body portion 22 surrounding the core mandrel end terminal 66 and rods 68. Once housing 12 is molded, the core mandrel is removed, thereby exposing inner cavity 32 of body portion 22.

Varistor elements 62 of block assembly 14 are then placed into inner cavity 32 through open end 28 of body portion 22 by first placing explosive charge 38 within cavity 32, and stacking varistor elements 62 on top of charge 38 and second end terminal 66. First end terminal 64 is placed on top of the stacked varistor elements 62 so that the ends of rods 68 extend through slots 70 of first end terminal 54. A compressive force is then applied to first end terminal 64, varistor elements 62, and second end terminal 66, through rods 68. The ends of rods 68 can then be cut off to be generally flush with first end terminal 64. First and second conductive terminals 18 and 20 can then be connected to block assembly 14 in the same manner as described above with respect to the first method of assembly.

Mounting arrester 10 to a utility pole requires coupling bracket portion 24 of arrester housing 12 with pole bracket 16 by inserting fastener 58 through a fastening hole of pole bracket 16 and through fastening hole 56 of bracket portion 24, and employing nut 60 for tightening fastener 58, thereby releasably mounting arrester 10 to the utility pole.

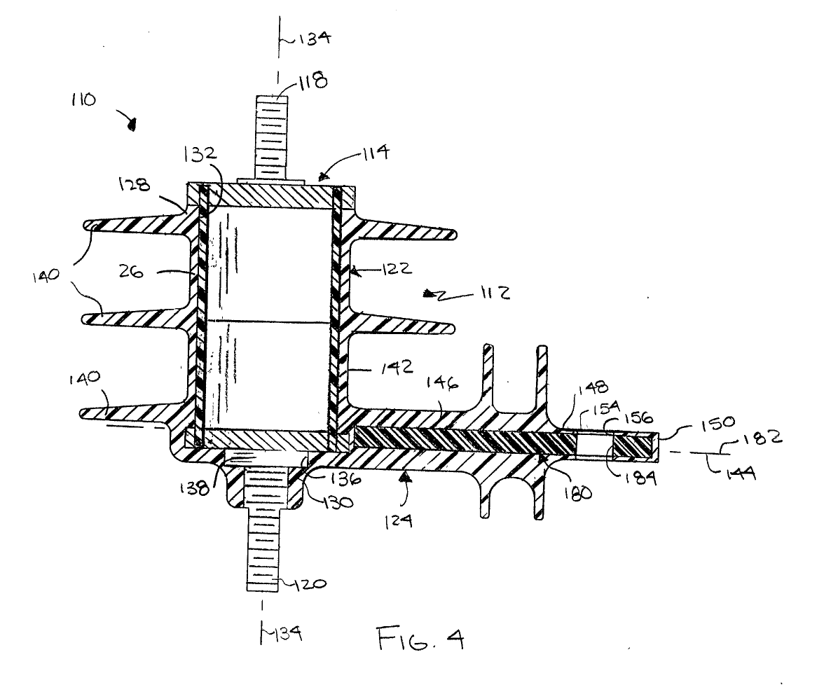

Embodiment of FIG. 4

Arrester 110 in accordance with a second embodiment of the present invention is the same as arrester 10, except for the addition of a rigid member 180 in the bracket portion 124 of arrester 110.

Like arrester 10, arrester 110 includes a housing 112 that has a body portion 122 and a support mounting bracket portion 124 that extends from body portion 122. Body portion 122 and bracket portion 124 form a one-piece unitary housing in the same manner as described above with respect to housing 12 of arrester 10. Body portion 122 receives block assembly 114 and bracket portion 124 supports arrester 110 with respect to pole bracket 16 (not shown in FIG. 4).

Body portion 122 of housing 112 generally includes a cylindrical wall 126 with opposing first and second ends 128 and 130 forming an inner cavity 132 therebetween for receiving block assembly 114 and defines a central longitudinal axis 134. First end 128 is near first conductive terminal 118 and is open to provide access to inner cavity 132. Second end 130 is unitary with bracket portion 124 and near second conductive terminal 120. A cavity 136 for receiving an explosive charge 138 is located in second end 130 between inner cavity 132 and second conductive terminal 120. A plurality of weather sheds 140 extend from an outer surface 142 of cylindrical wall 126, as is well known in the art. Although weather sheds 140 are preferably used, they are not necessary.

Bracket portion 124 extends laterally from second end 130 of body portion 122 and defines a longitudinal axis 144. Longitudinal axis 144 is substantially perpendicular to longitudinal axis 134 of body portion 122. Like bracket portion 24 of arrester 10, bracket portion 124 includes a generally cylindrical main section 146 extending from body portion 122 and a generally flat section 148 at a distal end 150 of bracket portion 124. Although main section 146 is preferably cylindrical, main section 146 can be any structural shape, such as square, T-shape, or U-shaped. The size and thickness of section 148 is determined by the strength required to support arrester 110 on pole bracket 16. Weather sheds 152 can be employed which extend from tubular section 46, but are not required. Flat section 148 includes a securing surface 154 that engages pole bracket 16. Specifically, securing surface 154 includes a fastening hole 156 disposed within flat section 148 that receives a fastener.

Rigid member 180 is located within bracket portion 124 to provide rigidity thereto. Rigid member 180 is preferably a thermo set plastic rod but can be any rigid material, such as fiberglass. Member 180 extends along substantially the entire length of bracket portion 124 between block assembly 114 and the distal end 150 of bracket portion 124 and defines a central longitudinal axis 182 that is co-axial with longitudinal axis 144 of bracket portion 124. A fastening hole 184 is located in the end 186 of rigid member 180 and aligns with fastening hole 156 of bracket portion 124 so that the fastener can extend through both bracket portion 124 and rigid member 180. Arrester 110 can then be mounted to pole bracket 16 in the same manner as described above with respect to arrester 10.

Varistor block assembly 114 is the same as block assembly 14 and therefore will not be described. Additionally, arrester 110 is assembled in the same manner as described above for arrester 10 except rigid member 180 is placed in the housing mold prior to molding housing 112 so that bracket portion 124 surrounds rigid member 180.

While particular embodiments have been chosen to illustrate the invention, it will be understood by those skilled in the art that various changes and modifications can be made therein without departing from the scope of the invention as defined in the appended claims.

What is claimed is:

1. An arrester, comprising:
a dielectric housing including,
a body portion having a substantially cylindrical wall with opposing first and second ends forming an inner cavity therebetween, and
a support mounting bracket portion formed as a unitary, one-piece extension of said body portion and extending laterally from said second end,
said housing having sufficient rigidity to maintain said bracket portion in a position substantially perpendicular to said body portion; and
at least one varistor element received in said inner cavity of said housing.

2. An arrester according to claim 1, wherein
said inner cavity of said housing receives an explosive charge near said second end of said body portion.

3. An arrester according to claim 1, wherein
said support mounting bracket portion includes a distal end with a securing surface that engages the support structure.

4. An arrester according to claim 3, wherein
said securing surface includes a fastener hole receiving a fastener.

5. An arrester according to claim 1, wherein
said housing is formed of a plastic polymer blend.

6. An arrester according to claim 1, wherein
said body portion includes weather sheds unitary with said body portion.

7. An arrester according to claim 1, wherein
said inner cavity of said housing receives a plurality of varistor elements; and
said varistor elements are supported between first and second end terminals.

8. An arrester according to claim 7, wherein
said inner cavity includes at least one rigid member extending between said first and second end terminals to compress said varistors supported between said first and second end terminals.

9. An arrester according to claim 7, wherein
said second end of said body portion includes a weakened section for directing the ventilation of internal gases.

10. An arrester, comprising:
a dielectric housing including,
a body portion having a substantially cylindrical wall with first and second ends forming an inner cavity therebetween,
a support mounting bracket portion formed as unitary, one-piece extension of said body portion and extending laterally from the second end, and said support mounting bracket having a rigid support member, and
said housing having sufficient rigidity to maintain said bracket portion in a position substantially perpendicular to said body portion; and
at least one varistor element received in said inner cavity of said housing.

11. An arrester according to claim 10, wherein
said rigid support member is disposed with said support mounting bracket portion and extends substantially the entire length thereof.

12. An arrester according to claim 11, wherein
said rigid support member is a plastic rod.

13. An arrester according to claim 10, wherein
said support mounting bracket portion includes a first fastening hole receiving a fastener, and
said rigid support member includes a second fastening hole that is substantially aligned with said first fastening hole and receives said fastener.

14. An arrester according to claim 10, wherein
said housing is formed of a plastic polymer blend.

15. A method of making an arrester having a dielectric housing that receives a plurality of varistor elements, comprising the steps of:
placing the plurality of varistor elements between first and second electrically conductive end terminals to form a block assembly;
placing the block assembly in a mold; and
molding the housing of the arrester around the block assembly so that the block assembly is received in a body portion of the housing and a support mounting bracket portion is formed as a unitary one-piece extension of the body portion.

16. A method of making an arrester according to claim 15, wherein
the housing is formed of a plastic polymer blend.

17. A method of making an arrester according to claim 15, further comprising the steps of
providing a rigid member between the first and second end terminals; and
applying tension to the rigid member, thereby compressing the plurality of varistor elements between the first and second end terminals.

18. A method of making an arrester according to claim 15, further comprising the steps of
molding the housing around a rigid support member so the rigid support member is received within the support mounting bracket portion of the housing.

19. A method of making an arrester having a housing that receives a plurality of varistor elements, comprising the steps of:
molding the housing of the arrester around a core mandrel so that the core mandrel is received in a body portion of the housing and a support mounting bracket portion is formed as a one-piece unitary extension of the body portion;
removing the core mandrel; and
placing the plurality of varistor elements and a first end terminal within the body portion.

20. A method of making an arrester according to claim 19, further comprising the steps of
placing a second end terminal with the body portion so that the plurality of varistor elements are between the first and second end terminals;
providing a rigid member between the first and second end terminals; and
applying tension to the rigid member, thereby compressing the first and second end terminals and the plurality of varistor elements.

21. A method of making an arrester according to claim 19, wherein
the housing is formed of a plastic polymer blend.

22. A method of making an arrester according to claim 20, further comprising the steps of
molding the housing around a rigid support member so that the rigid support member is received in the support mounting portion of the housing.
